(19) United States
(12) Patent Application Publication
(10) Pub. No.: US 2018/0219676 A1
(43) Pub. Date: Aug. 2, 2018

(54) MANAGING SMART APPLIANCES USING BLOCKCHAIN TECHNOLOGY

(71) Applicant: Walmart Apollo, LLC, Bentonville, AR (US)

(72) Inventors: Todd Mattingly, Bentonville, AR (US); Donald Ray High, Noel, MO (US); Bruce Wilkinson, Rogers, AR (US); Brian McHale, Oldham (GB); Robert Cantrell, Herndon, VA (US); John Jeremiah O'Brien, V, Farmington, AR (US); Joseph Jurich, JR., Molino, FL (US)

(21) Appl. No.: 15/881,705

(22) Filed: Jan. 26, 2018

Related U.S. Application Data
(60) Provisional application No. 62/451,184, filed on Jan. 27, 2017.

(51) Int. Cl. H04L 9/32; H04L 29/06

(52) U.S. Cl. CPC H04L 9/32; H04L 63/10

(57) ABSTRACT

Examples of the disclosure provide systems and methods for managing a smart appliance. A computing system receives, from a smart appliance associated with an appliance type, a transaction request associated with a transfer between a user and a profile manager, and determines whether a transaction ledger includes transaction data associated with a reference transaction. The reference transaction is associated with a reference configuration of an appliance associated with the appliance type. On condition that the transaction ledger includes the transaction data, the computing system transmits a configuration instruction to the smart appliance to automatically configure the smart appliance to operate in accordance with the reference configuration, and communicates with one or more nodes in a network to validate a transaction associated with the transfer.

### BACKGROUND

Appliances may be used to perform one or more operations to accomplish one or more particular tasks. Some appliances may include and/or use communication systems that allow its users to remotely control or manage the appliances. Other users, however, may exploit the communication systems to access and/or use an appliance. To protect the appliances, security systems may be used to restrict unauthorized users from accessing and/or using the appliances. At least some known security systems, however, are limited to the appliance itself.

### SUMMARY

Examples of the disclosure provide a computer-implemented method for managing one or more smart appliances. The computer-implemented method includes receiving, from a smart appliance associated with an appliance type, a transaction request associated with a transfer between a user and a profile manager, and determining whether a transaction ledger includes transaction data associated with a reference transaction. The reference transaction is associated with a reference configuration of an appliance associated with the appliance type. On condition that the transaction ledger includes the transaction data, the computer-implemented method includes transmitting a configuration instruction to the smart appliance to automatically configure the smart appliance to operate in accordance with the reference configuration, and communicating with one or more nodes in a network to validate a transaction associated with the transfer.

In another aspect, a computing system is provided for managing a smart appliance. The computing system includes a memory device storing data associated with the smart appliance and computer-executable instructions, and a processor configured to execute the computer-executable instructions. The smart appliance is associated with an appliance type. The computer-executable instructions are executed to identify a network including one or more nodes, transmit a transaction request associated with a transfer between a user and a profile manager to the nodes, receive a configuration instruction from the nodes to configure the smart appliance to operate in accordance with a reference configuration associated with the appliance type, and receive a notification associated with a validation of a transaction from the one or more nodes. The transaction is associated with the transfer.

In yet another aspect, one or more computer storage media embodied with computer-executable instructions are provided. The computer storage media include a client component, a consensus component, a manager component, and a trigger component. The client component receives a transaction request associated with a transfer between a first user and a profile manager, and transmits a response to the transaction request. The consensus component transmits a local instance of the transaction request to one or more nodes in a network, receives one or more remote instances of the transaction request from the nodes in the network, and implements a consensus protocol to validate a transaction associated with the transfer. The manager component identifies a reference transaction associated with a reference configuration of an appliance associated with an appliance type. The trigger component monitors the user and/or the appliance and, if a smart appliance associated with the appliance type is identified, automatically configures the smart appliance to operate in accordance with the reference configuration.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating an example system for managing one or more smart appliances using a computing device.

FIG. 2 is a block diagram illustrating an example appliance management environment that may be used with a computing device, such as the computing device shown in FIG. 1.

FIG. 3 is a block diagram illustrating an example appliance management environment operating as a cloud-based service using blockchain technology.

FIG. 4 is a block diagram illustrating an example appliance management environment operating as a cloud-based service using a distributed network.

FIG. 5 is a flowchart illustrating an example method for managing one or more smart appliances using a computing device, such as the computing device shown in FIG. 1.

FIGS. 6 and 7 are sequence diagrams illustrating example methods for managing one or more smart appliances using a distributed network, such as the distributed network shown in FIG. 4.

FIG. 8 is a block diagram illustrating an example operating environment for a computing device, such as the computing device shown in FIG. 1.

Corresponding reference characters indicate corresponding parts throughout the drawings.

### DETAILED DESCRIPTION

Referring to the figures, examples of the disclosure enable one or more smart appliances to be controlled or managed. Blockchain technology, for example, may be used to facilitate the control and/or management of the smart appliance. A blockchain may be used as a public ledger including an ordered and timestamped record of transactions. The examples described herein enable one or more transactions associated with smart appliance to be administered or managed in accordance with a reference configuration of the smart appliance.

Aspects of the disclosure provide for a computing device that performs one or more operations in an environment including a plurality of devices coupled to each other via a network (e.g., a local area network (LAN), a wide area network (WAN), the Internet). For example, a computing device may communicate with one or more other computing devices, including one or more appliances and/or user devices, to facilitate appliance management. In some embodiments, the computing device analyzes data associated with an appliance to facilitate a transaction between a user and a profile manager.

The systems and processes described herein may be implemented using computer programming or engineering techniques including computer software, firmware, hardware or a combination or subset thereof. Aspects of the disclosure improve processor security, data integrity, data storage security, data security in networked devices, data transmission security, and/or communication between computing systems by controlling communications and managing access to various accounts using a public key cryptographic system and/or by verifying and validating transaction data using a proof-of-work protocol and a consensus protocol. Additionally, some aspects may improve user experience, user efficiency, and/or user interaction performance by facilitating transactions in an effective and efficient manner. Moreover, some aspects may increase processor speed, improve operating system resource allocation, and/or reducing error rate by automating the processing of large volumes of data.

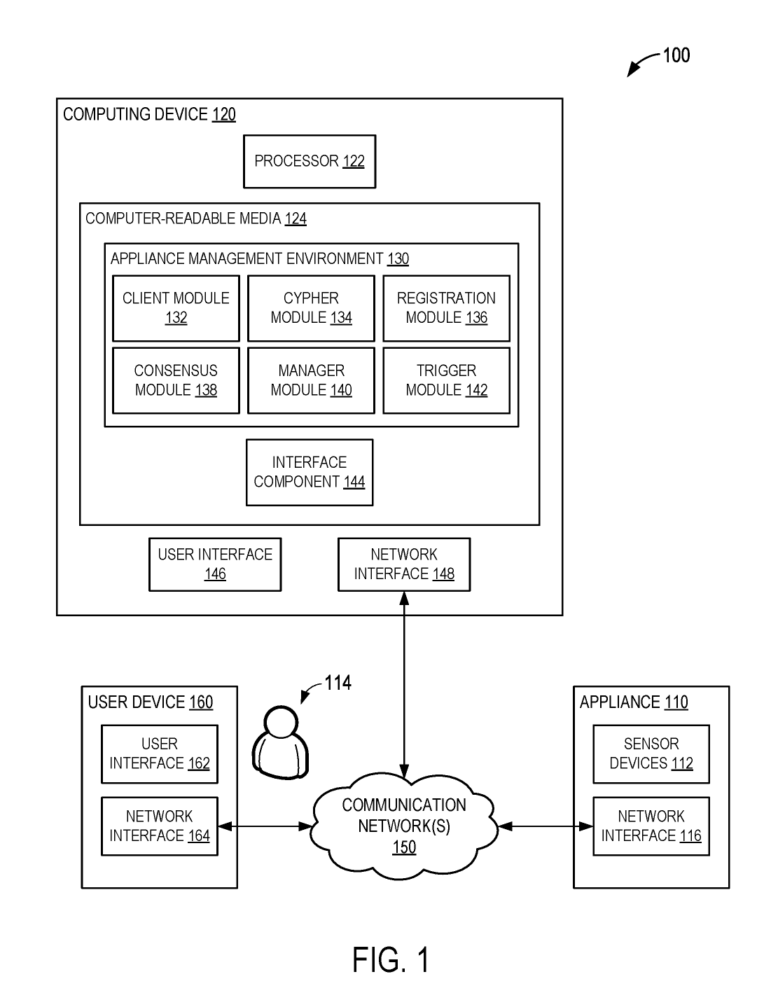

FIG. 1 is a block diagram illustrating an example system 100 for managing one or more smart appliances. The system 100 includes a plurality of “things,” such as a smart appliance or appliance 110. For example, the system 100 may be an Internet of Things (IoT) ecosystem. The appliance 110 is configured to perform one or more operations to accomplish one or more particular tasks. The appliance 110 may be or include a physical appliance and/or a virtual appliance. Example appliances 110 include household appliances, consumer electronics, monitoring systems, intelligent agents, smart devices, tangible user interfaces, holographic user interfaces, kinetic user interfaces, motion tracking interfaces, non-command user interfaces (e.g., inferences based on user observation used as input), zero-input interfaces (e.g., sensor data used as input), natural user interfaces, and the like.

The appliance 110 includes one or more input devices or sensor devices 112 configured to collect sensor data associated with its environment. Example sensor devices 112 include machine vision sensors, imaging sensors, infrared sensors, optical sensors, ambient light sensors, accelerometers, gyroscopes, velocity sensors, sound sensors, acoustic sensors, ultrasonic sensors, electric sensors, magnetometers, near field communication (NFC) sensors, radio-frequency identification (RFID) sensors, global positioning system (GPS) sensors, position sensors, motion detectors, presence sensors, proximity sensors, touch sensors, force sensors, load sensors, pressure sensors, torque sensors, strain sensors, flow sensors, displacement sensors, thermometers, barometers, humidity sensors, moisture sensors, leak sensors, level sensors, chemical sensors, gas sensors, and the like. In some examples, the sensor devices 112 process or analyze the sensor data to generate profile information associated with the appliance 110 and/or with one or more users 114 of the appliance 110. Example profile information includes identifier data, type data, configuration data, time data, location data, usage data, preference data, context data, and the like. The sensor devices 112 may be internal to the appliance 110 (as shown in FIG. 1), external to the appliance 110, or both.

The appliance 110 uses a network interface 116 to transmit data (e.g., sensor data, profile information) to and/or receive data from one or more computing systems. In some examples, the network interface 116 formats data and controls data exchange using an Open Systems Interconnection (OSI) model to enable the appliance 110 to communicate with one or more computing systems using one or more communication protocols. Example communication protocols include WI-FI® brand communication protocols, BLUETOOTH® brand communication protocols, ZIGBEE® brand communication protocols, Z-WAVE™ brand communication protocols, Internet Protocol (IP) communications protocols, NFC communication protocols, RFID communication protocols, cellular communication protocols, and the like. (WI-FI® is a registered trademark of Wi-Fi Alliance, BLUETOOTH® is a registered trademark of Bluetooth Special Interest Group, ZIGBEE® is a registered trademark of ZigBee Alliance Corporation, and Z-WAVE™ is a trademark of Sigma Designs, Inc.). In some examples, the network interface 116 identifies and/or locates one or more computing devices to enable the data to be selectively routed. Additionally, or alternatively, the network interface 116 may enable the computing devices to identify and/or locate the appliance 110.

The system 100 includes a computing device 120 configured to administer or monitor the IoT ecosystem. For example, the computing device 120 may detect the appliance 110 and communicate with the appliance 110 to facilitate controlling or managing the appliance 110. The computing device 120 includes one or more computing systems that execute instructions (e.g., as application programs, operating system functionality, or both) to implement one or more operations as described herein. In some examples, the computing device 120 includes a group of processing units or other computing systems. The computing device 120 may include, for example, a desktop computer, a server computer, a kiosk, a set top box, and/or a tabletop device. Additionally, or alternatively, the computing device 120 may include more-portable computing devices, such as a mobile device, a laptop computer, a tablet device, a netbook, a gaming device, a wearable device, and/or a portable media player.

In some examples, the computing device 120 has at least one processor 122 and computer-readable media 124. The processor 122 includes any quantity of processing units, and is programmed to execute computer-executable instructions for implementing aspects of the disclosure. The instructions may be performed, for example, by one or more processors 122 within the computing device 120 (as shown in FIG. 1). Additionally, or alternatively, the instructions may be performed by at least one processor external to the computing device 120. The processor 122 may represent an implementation of analog techniques to perform the operations described herein. For example, the operations may be performed by an analog computing device and/or a digital computing device.

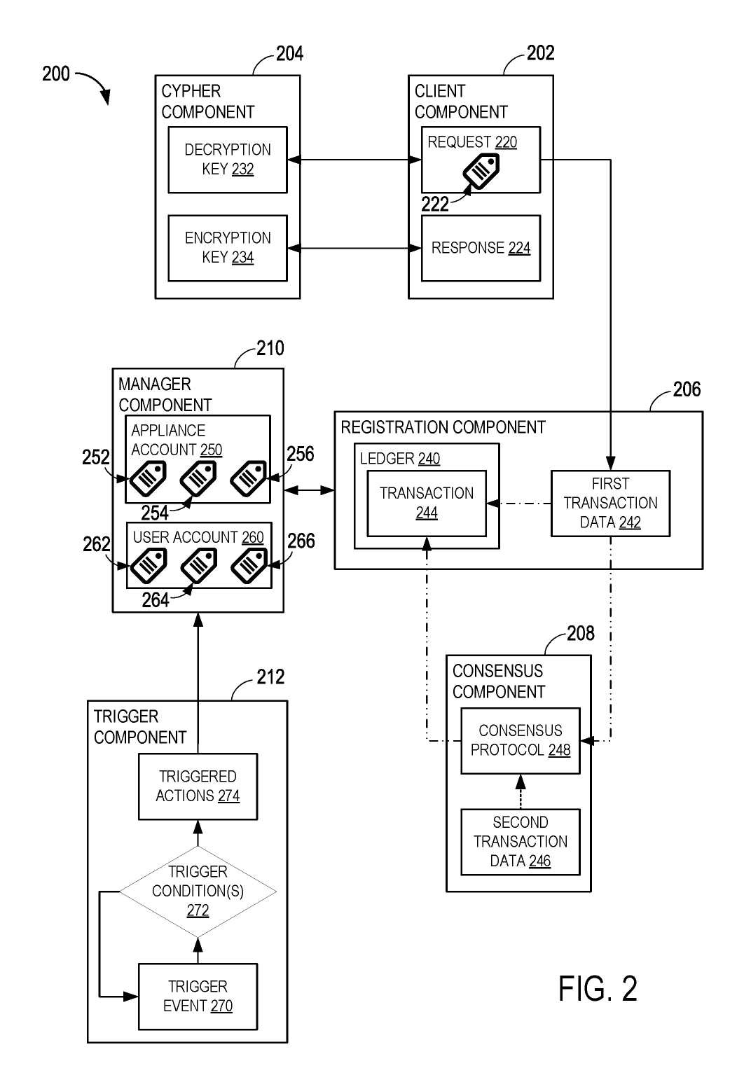

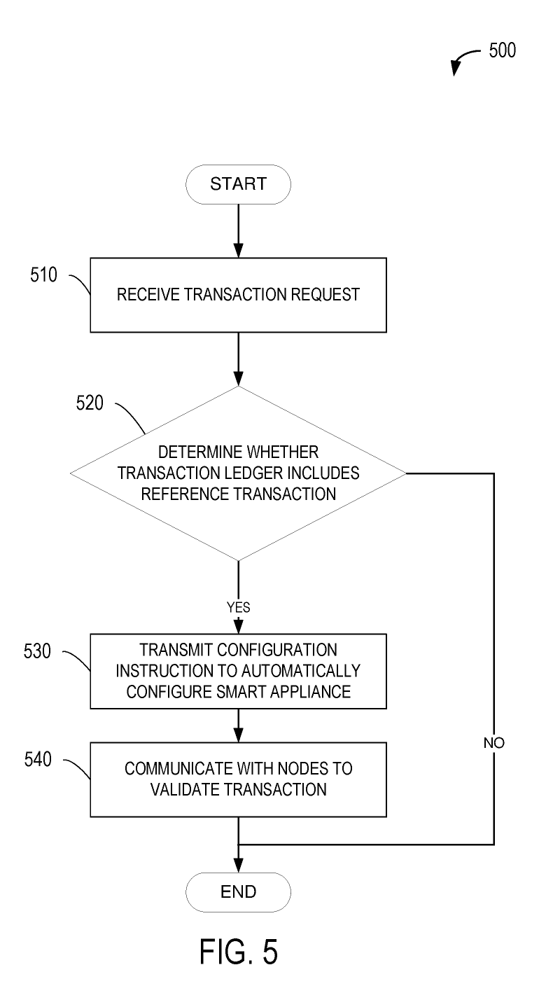

In some examples, the processor 122 is programmed to execute instructions, such as those illustrated in the figures (e.g., FIGS. 2, 5 6, and 7). The instructions may be stored and/or maintained at the computer-readable media 124. The computer-readable media 124 includes any quantity of media associated with or accessible by the computing device 120. The computer-readable media 124 may be internal to the computing device 120 (as shown in FIG. 1), external to the computing device 120, or both. For example, the computer-readable media 124 may include data stored locally at the computing device 120, data access points stored locally at the computing device 120 and associated with data stored remote from the computing device 120, or any combination of local and remote data. In some examples, the computer-readable media 124 includes read-only memory and/or memory wired into an analog computing device.

The computer-readable media 124 stores and/or maintains, among other data, one or more applications. The applications, when executed by the processor 122, operate to perform one or more operations and/or provide functionality on the computing device 120. Example applications include an appliance management environment 130, which may represent an application for facilitating appliance management. The appliance management environment 130 may provide one or more computer-executable components for managing the appliance 110. In some examples, the appliance management environment 130 includes a client module 132, a cypher module 134, a registration module 136, a consensus module 138, a manager module 140, and a trigger module 142.

The client module 132 is a component of the appliance management environment 130 that identifies one or more transaction requests. The client module 132 is configured to receive and/or identify one or more incoming messages. The incoming messages may be analyzed to determine whether the incoming messages include and/or are associated with a transaction request.

In some examples, the client module 132 is configured to identify and/or locate one or more other computing systems (e.g., appliance 110) and transmit one or more outgoing messages to the other computing systems. The outgoing messages may be transmitted, for example, to one or more computing systems in response to the transaction requests. In some examples, the client module 132 authenticates one or more computing systems and/or users (e.g., user 114).

The cypher module 134 is a component of the appliance management environment 130 that transforms data between a plurality of forms. The cypher module 134 may be used, for example, to protect the computing device 120, the appliance management environment 130, and/or data transmitted to and/or from the appliance management environment 130. The cypher module 134 is configured to convert readily-unintelligible data into readily-intelligible data. A message including encrypted information in cyphertext form, for example, may be decrypted to generate and/or identify information in plaintext form. In some examples, the cypher module 134 is configured to convert readily-intelligible data into readily-unintelligible data. A message including information in plaintext form, for example, may be encrypted to generate and/or identify encrypted information in cyphertext form.

The registration module 136 is a component of the appliance management environment 130 that processes one or more transaction requests. The registration module 136 is configured to analyze the transaction requests to determine whether to approve or not approve (e.g., reject) the transaction requests. In some examples, the registration module 136 generates transaction data associated with the transaction requests. Transaction data associated with one or more approved transaction requests may be registered, for example, to enable one or more computing systems to identify and/or locate a transaction associated with the transaction data. Transaction data may include, for example, a transaction identifier, a device identifier, a user identifier, a transaction date, a transaction time, a transaction location, and/or a transaction amount.

The consensus module 138 is a component of the appliance management environment 130 that validates one or more transactions associated with one or more transaction requests. The consensus module 138 is configured to determine whether the transaction data associated with the transaction requests is reliable, or at least likely to be reliable. In some examples, the consensus module 138 compares the transaction data with other data to determine whether the other data corroborates or supports the transaction data. The consensus module 138 may determine that the transaction data is reliable, for example, if the other data corroborates or supports the transaction data. One or more transactions associated with one or more transaction requests may be validated on condition that transaction data associated the transaction requests is determined to be reliable.

The manager module 140 is a component of the appliance management environment 130 that administers or manages one or more appliances 110. The manager module 140 is configured to analyze transaction data to identify one or more appliances 110 and/or users 114, and administers or manages one or more accounts associated with the appliances 110 and/or users 114 based on the transaction data. In some examples, the manager module 140 generates and/or modifies profile information associated with the appliances 110 and/or users 114. The profile information may be representative of a state or configuration of the appliance 110.

The trigger module 142 is a component of the appliance management environment 130 that monitors one or more appliances 110 and/or users 114 associated with the accounts. The trigger module 142 is configured to perform one or more predetermined operations in accordance with profile information associated with the appliances 110 and/or users 114. In some examples, the trigger module 142 uses profile information to automatically configure an appliance 110. Additionally, or alternatively, the trigger module 142 may use the profile information to generate and/or transmit one or more alerts or notifications associated with the appliance 110 and/or user 114.

In some examples, the computing device 120 includes an interface component 144 stored and/or maintained at the computer-readable media 124. When executed by the processor 122, the interface component 144 may cause the computing device 120 to perform one or more operations and/or provide functionality that facilitate appliance management communication. The interface component 144 may include computer-executable instructions (e.g., a driver) for operating one or more user interfaces 146 and/or network interfaces 148.

A user interface 146, for example, may be used to present information to and/or receive user input from a user of the computing device 120. User interfaces 146 may include any output and/or input device that enables information to be presented to and/or received from the user, such as a display device, a monitor, a touchscreen panel, a graphics card, a speaker, a sound card, a printer, a vibration motor, a natural user interface, a tablet, a microphone, a keyboard, a pointing device, a sensor device, a digital camera, an accelerometer, and the like. The user interfaces 146 may be internal to the computing device 120 (as shown in FIG. 1), external to the computing device 120, or both.

A network interface 148 may be used to transmit data to and/or receive data from one or more other computing systems (e.g., appliance 110). Network interfaces 148 may include any output and/or input device that enables information to be presented to and/or received from another computing system, such as a modem, a network interface controller (NIC), a WI-FI® brand local area wireless computing network-enabled device, a BLUETOOTH® brand wireless technology-enabled device, a ZIGBEE® brand wireless technology-enabled device, Z-WAVE™ brand wireless technology-enabled device, and/or an NFC wireless communication-enabled device. The network interfaces 148 may be internal to the computing device 120 (as shown in FIG. 1), external to the computing device 120, or both.

In some examples, one or more applications, such as the appliance management environment 130, communicate with counterpart applications or services such as web services accessible via one or more communication networks 150 that enable data to be transferred between a plurality of computing systems coupled to the communication network 150. For example, the applications may represent server-side applications that enable client-side services to be provided at one or more client devices (e.g., appliances 110).

In some examples, the computing device 120 communicates with a user device 160 (e.g., via the communication network 150) to provide cloud-based services to the user 114. For example, the user 114 may use the user device 160 to remotely operate the appliance 110. In some examples, the user device 160 provides an instance of the appliance management environment 130 (e.g., a client-side application) for presenting information to and/or receiving user input from the user 114 while appliance management operations are performed on the backend at the computing device 120. The user device 160 may include an operating system that enables the instance of the appliance management environment 130 to be provided in a user-friendly manner. For example, the operating system may include one or more application program interfaces (APIs) that enable the user device 160 to present information to and/or receive user input from the user 114 using a user interface 162 and/or transmit data to and/or receive data from one or more other computing systems (e.g., appliance 110, computing device 120) using a network interface 164.

In some examples, user device 160 may be provisioned as a federated entity to be used in hosting and providing a private key of the associated user, such as user 114, to the distributed ledger used to maintain and control the transactions associated with appliance 110. User device 160 may be used to provision and/or deprovision access of appliance 110 to the user's network of devices, in some examples. User device 160 may enable a user to configure customized levels of control and access per device (e.g. appliance 110) using the instance of the appliance management environment 130 implemented on user device 160. Customized levels of control and access may include: limited access, one-time access, full-authority access, specific channels of activity access, and any other suitable control customization. In other examples, user device 160 may be provisioned to provide private key information for authenticating and/or provisioning other devices, but may have restricted management access or otherwise limited authority.

FIG. 2 is a block diagram illustrating an example appliance management environment 200 for managing appliance 110. The appliance management environment 200 is an example of one implementation of the appliance management environment 130 in FIG. 1. The appliance management environment 200 includes a client component 202, a cypher component 204, a registration component 206, a consensus component 208, a manager component 210, and a trigger component 212.

The client component 202 is configured to identify a transaction request 220. The transaction request 220 may be associated with, for example, an establishment of a communication link, an implementation of a configuration, and/or an installation of firmware. The client component 202 may communicate with one or more other computing systems (e.g., appliance 110, user device 160) to receive one or more messages. In some examples, the client component 202 processes or analyzes a message to determine whether the message is, includes, or is associated with a transaction request 220. For example, a message including one or more identifiers 222 may be interpreted and/or identified as a transaction request 220. Example identifiers 222 may include a transaction identifier, an appliance identifier, user credentials, and the like.

In some examples, the client component 202 communicates with the appliance 110 and/or user device 160 to transmit one or more messages. For example, the client component 202 may transmit a response 224 to a transaction request 220 received from the appliance 110 and/or user device 160. The client component 202 may analyze the transaction request 220 to generate the response 224. Additionally, or alternatively, the client component 202 may analyze the transaction request 220 to identify and/or locate the appliance 110 and/or user device 160. In some examples, the user device 160 may be identified and/or located using one or more identifiers 222 included in or associated with the transaction request 220.

The cypher component 204 is configured to transform data between a readily-unintelligible form and readily-intelligible form. The cypher component 204 may communicate with the client component 202 to obtain one or more encrypted messages received from the appliance 110 and/or user device 160, such as an encrypted transaction request 220. In some examples, the cypher component 204 processes or analyzes an encrypted message using a decryption key 232 to generate intelligible information (e.g., in plaintext form) corresponding to the encrypted message.

In some examples, the cypher component 204 communicates with the client component 202 to provide one or more encrypted messages for transmission to the appliance 110 and/or user device 160. For example, the cypher component 204 may process a response 224 using an encryption key 234 to generate unintelligible data (e.g., in cyphertext form) corresponding to the response 224 (e.g., an encrypted response 224), and communicate with the client component 202 for transmitting the encoded response 224 to the appliance 110 and/or user device 160.

The registration component 206 is configured to maintain or manage a record or ledger 240. The ledger 240 enables a state or configuration of the appliance 110 to be monitored and managed. The registration component 206 may communicate with the client component 202 and/or cypher component 204 to obtain one or more transaction requests 220. In some examples, the registration component 206 processes or analyzes the transaction request 220 to identify and/or generate first transaction data 242 associated with the transaction request 220. The first transaction data 242 may be used to determine whether to approve or not approve the transaction request 220 and/or whether to record or register the first transaction data 242 in the ledger 240.

In some examples, the registration component 206 determines whether the appliance 110 associated with the transaction request 220 is legitimate, whether the user 114 associated with the transaction request 220 is legitimate or authorized to enter into a transaction, and/or whether the user 114 agrees to enter into the transaction. If the appliance 110 is not legitimate (e.g., counterfeit), the user 114 is not authorized (e.g., unauthorized), and/or the user 114 does not agree, the registration component 206 does not approve the transaction request 220 and/or does not register the first transaction data 242 in the ledger 240. On the other hand, if the appliance 110 is legitimate, the user 114 is authorized, and the user 114 agrees, the registration component 206 approves the transaction request 220 and/or registers the first transaction data 242 in the ledger 240.

The consensus component 208 is configured to validate a transaction 244 associated with the transaction request 220. The consensus component 208 may communicate with the registration component 206 to obtain first transaction data 242 associated with the transaction request 220. Additionally, the consensus component 208 may communicate with one or more other computing systems to determine whether the first transaction data 242 is reliable. In some examples, the consensus component 208 transmits the first transaction data 242 (e.g., a local instance of the transaction request 220) to the other computing systems and/or receive second transaction data 246 associated with the transaction request 220 (e.g., one or more remote instances of the transaction request 220) from the other computing systems.

If the first transaction data 242 is the same as or consistent with the second transaction data 246 (e.g., if the second transaction data 246 corroborates or supports the first transaction data 242), the consensus component 208 validates the transaction 244 using the first transaction data 242 and/or the second transaction data 246. On the other hand, if the first transaction data 242 is inconsistent (e.g., conflicts) with the second transaction data 246, the consensus component 208 settles or reconciles one or more inconsistencies between the first transaction data 242 and the second transaction data 246, and validates the transaction 244 using the reconciled transaction data (e.g., first transaction data 242, second transaction data 246, or other transaction data). The inconsistencies may be settled, for example, using a consensus protocol 248.

The manager component 210 is configured to administer or manage one or more appliances 110. The manager component 210 may communicate with the registration component 206 to identify one or more appliances 110 associated with the transaction 244, and administer or manage one or more appliance accounts 250 associated with the appliances 110. An appliance account 250 may include or be associated with profile information, such as an appliance identifier 252, an appliance type 254, and configuration data 256. The appliance identifier 252 includes any data that enables the appliance 110 to be identified and/or authenticated. Example appliance identifiers 252 include appliance names, identification numbers, serial numbers, media access controller (MAC) addresses, Uniform Resource Identifiers (URIs), public key infrastructure (PKI) certificates, security tokens, BLUETOOTH® brand wireless technology identifiers, ZIGBEE® brand wireless technology identifiers, Z-WAVE™ brand wireless technology identifiers, IP addresses, NFC identifiers, RFID identifiers, phone numbers, and the like. Example appliance types 254 include air conditioners, heaters, water heaters, clothes dryers, clothes washers, dishwashers, refrigerators, freezers, microwave ovens, stoves, trash compactors, juicers, mixers, blenders, food processors, coffee makers, toasters, televisions, kiosks, server systems, media systems, communication systems, user interfaces, and the like.

Additionally, the manager component 210 may identify one or more users 114 associated with the transaction 244, and administer or manage one or more user accounts 260 associated with the users 114. A user account 260 may include account data, such as user credentials 262, contact data 264, and appliance data 266. The user credentials 262 include any data that enables the user 114 to be identified and/or authenticated. For example, the user credentials 262 may be used to selectively allow the user 114 to access and use the account data. Example user credentials 262 include usernames, identification numbers, passwords, personal identification numbers (PINs), signatures, voiceprints, body postures or gestures, biometric data, PKI certificates, security tokens, phone numbers, email addresses, mailing addresses, and the like. Contact data 264 includes any data that enables the user 114 to be located and/or approached for establishing a communication link for communicating with the user 114, such as a phone number, an email address, a mailing address, and the like. Appliance data 266 demonstrates and/or substantiates that the user 114 is associated with one or more appliances 110. For example, the appliance data 266 may allow the user 114 to access and/or use the appliances 110 and/or data associated with the appliances 110 (e.g., profile information). In some examples, the appliance data 266 includes or is associated with the profile information associated with the appliances 110.

The trigger component 212 is configured to monitor the appliances 110 and/or users 114 associated with the appliance accounts 250 and/or user accounts 260, respectively. The trigger component 212 may communicate with the manager component 210 to identify profile information associated with the appliance accounts 250 and/or user accounts 260 for performing one or more predetermined operations. In some examples, the trigger component 212 communicates with the registration component 206 to identify one or more transactions 244 associated with a triggering event 270. Example triggering events 270 include a communication link being established, a configuration becoming available, firmware becoming available, and the like.

Upon detecting and/or identifying an occurrence of a triggering event 270, the trigger component 212 evaluates one or more predetermined trigger conditions 272 to determine whether to perform one or more triggered actions 274. Example trigger conditions 272 include an appliance configuration, an appliance state, a configuration state, an appliance location, and the like. If the trigger conditions 272 are not satisfied, the trigger component 212 continues to monitor the appliances 110 and/or users 114. On the other hand, if the trigger conditions 272 are satisfied, the trigger component 212 performs the triggered actions 274. The triggered actions 274 may be performed, for example, to configure the appliance 110, determine a reference configuration, modify the reference configuration, install firmware, modify profile information, and/or generate a notification associated with the appliance 110.

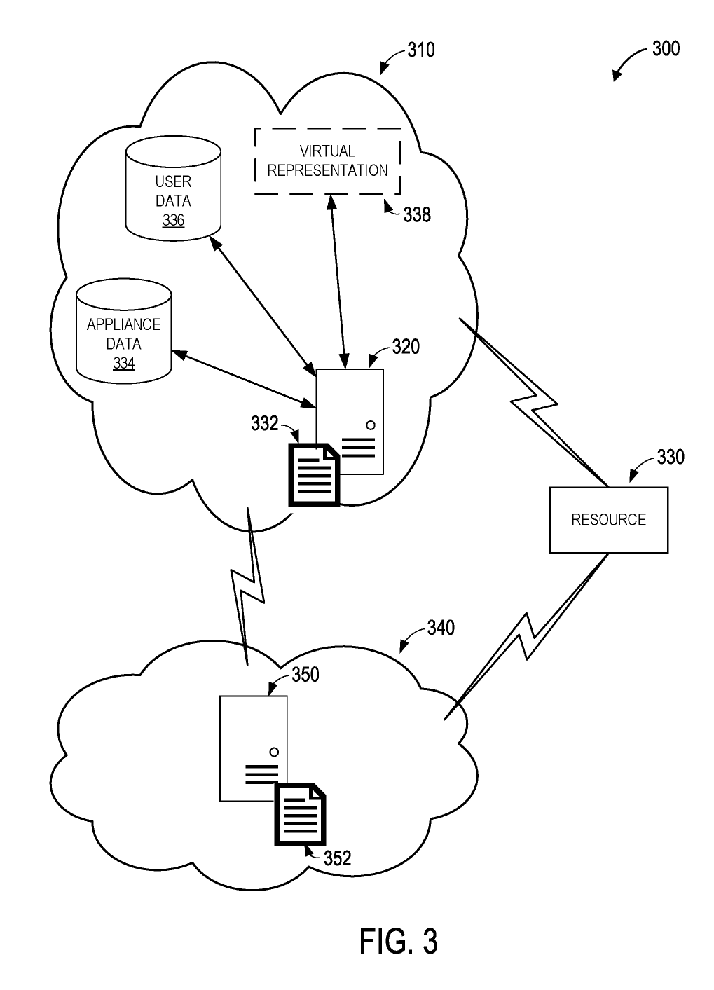

FIG. 3 is a block diagram illustrating an example appliance management environment 300 operating as a cloud-based service using blockchain technology. The appliance management environment 300 may be an illustrative example of the appliance management environment 130 in FIG. 1 and/or the appliance management environment 200 in FIG. 2. The appliance management environment 300 may be implemented in a cloud-based environment, such as an IoT server network 310, with one or more operations performed in the cloud. For example, one or more appliance management operations, such as those depicted in FIGS. 2, 5, 6, and 7, may be performed at the IoT server network 310.

The IoT server network 310 may be communicatively coupled to one or more computing systems or resources in an IoT ecosystem via a communication network (e.g., communication network 150). The IoT server network 310 includes one or more primary or first server systems 320 (e.g., computing device 120) that use one or more server-side applications to provide one or more client-side services at one or more other resources in the IoT ecosystem. Additionally, or alternatively, a resource may use one or more client-side applications to present and/or obtain information while appliance management operations are performed on the backend at a first server system 320.

A resource 330 (e.g., appliance 110, user device 160), for example, may transmit a transaction request 220 to the first server system 320 to initiate a session through which one or more transactions (e.g., transaction 244) may transpire. The transaction request 220 may be processed to generate first transaction data 332 (e.g., first transaction data 242). In some examples, the first server system 320 analyzes the first transaction data 332 to identify the resource 330 and/or a user associated with the resource 330 (e.g., user 114) for administering or managing one or more accounts associated with the transaction request 220 (e.g., appliance account 250, user account 260). Appliance data 334 associated with the resource 330 (e.g., appliance account 250) and/or user data 336 associated with the user 114 (e.g., user account 260), for example, may be generated and/or modified based on the first transaction data 332.

The first server system 320 may store and/or maintain one or more virtual representations 338 of the resource 330. The virtual representation 338 may be representative, for example, of a state or configuration of the resource 330. In some examples, the first server system 320 generates a virtual representation 338 using appliance data 334 and/or user data 336. Additionally, or alternatively, the first server system 320 may receive a virtual representation 338 from one or more computing systems. The virtual representation 338 may be, include, or be associated with a Representational State Transfer (REST) API that enables the resource 330 to provide a current state or configuration of the resource 330 to and/or obtain a desired state or configuration of the resource 330 (e.g., a reference configuration) from the first server system 320.

A blockchain server network 340 may support one or more appliance management operations performed in the IoT ecosystem. The blockchain server network 340 includes one or more secondary or second server systems 350 that use one or more server-side applications to provide one or more client-side services at one or more other resources in the IoT ecosystem. Additionally, or alternatively, a resource may use one or more client-side applications to present and/or obtain information while blockchain operations are performed on the backend at a second server system 350.

The first server system 320 may transmit first transaction data 332 to the second server system 350 to validate a transaction 244 associated with the first transaction data 332. For example, the first transaction data 332 may be compared with second transaction data 352 stored and/or maintained at the second server system 350 (e.g., second transaction data 246). In some examples, the first server system 320 validates the transaction 244 on condition that the second transaction data 352 corroborates or supports the first transaction data 332.

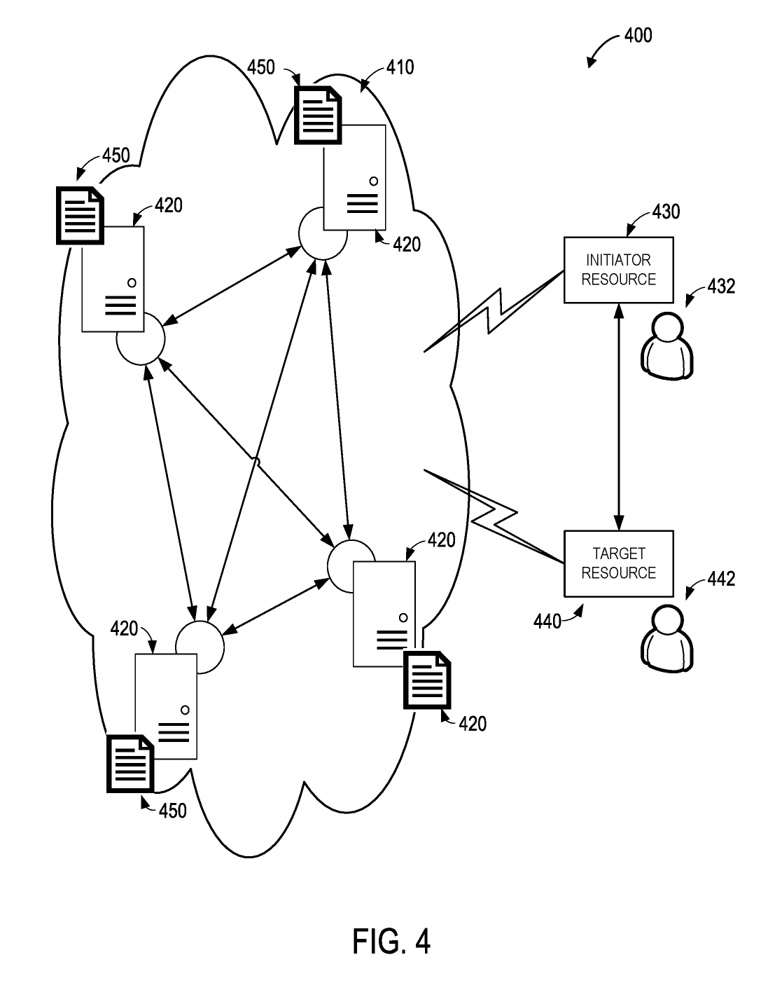

FIG. 4 is a block diagram illustrating an example appliance management environment 400 operating as a cloud-based service using a distributed network 410. The appliance management environment 400 may be an illustrative example of the appliance management environment 130 in FIG. 1 and/or the appliance management environment 200 in FIG. 2. The appliance management environment 400 may be implemented in a cloud-based environment, such as a distributed network 410, with one or more operations performed in the cloud. For example, one or more appliance management operations, such as those depicted in FIGS. 2, 5, 6, and 7, may be performed at the distributed network 410.

The distributed network 410 may be communicatively coupled to one or more computing systems or resources (e.g., appliance 110, computing device 120, user device 160) in an IoT ecosystem via a communication network (e.g., communication network 150). The distributed network 410 includes a plurality of nodes 420 (e.g., second server system 350) that use one or more server-side applications to provide one or more client-side services at the resources. Additionally, or alternatively, a resource may use one or more client-side applications to present and/or obtain information while appliance management operations are performed on the backend at a node 420.

A resource in the IoT ecosystem may be associated with one or more roles and, thus, is associated with a single role in the context of a single corresponding transaction. An initiator resource 430 associated with a first user 432 may be used to transmit a request message to a target resource 440 associated with a second user 442. The request message may be transmitted, for example, to initiate or start a session between the initiator resource 430 and the target resource 440. In some examples, the request message is associated with controlling or monitoring the initiator resource 430 or target resource 440 and/or with transmitting sensor data or profile information between the initiator resource 430 and target resource 440. The target resource 440 processes the request message and, in some examples, transmits a response message to the initiator resource 430. The request message may be analyzed, for example, to determine whether to approve or not approve the request message.

In some examples, the initiator resource 430 and/or target resource 440 generates a transaction request 220 associated with a transfer between the first user 432 and second user 442, and broadcasts the transaction request 220 to the distributed network 410. In this manner, one or more nodes 420 in the distributed network 410 may obtain the transaction request 220. The transaction request 220 may be generated, for example, using a private key, a public key, and/or a representation of a key (e.g., an encrypted key, a hash, an encrypted hash).

Upon obtaining the transaction request 220, a node 420 processes the transaction request 220 to generate transaction data 450 (e.g., first transaction data 242, second transaction data 246) and broadcasts the transaction data 450 to the distributed network 410. Each node 420 that obtains a transaction request 220 may independently process the transaction request 220 to generate an instance of the transaction data 450. In this manner, a node 420 may transmit an instance of the transaction data 450 that is local to that node 420 (e.g., a local instance) to one or more other nodes 420 and/or receive one or more instances of the transaction data 450 that are local to one or more other nodes 420 (e.g., one or more remote instances) from those other nodes 420. A node 420 may be configured to broadcast transaction data 450 that is new to that node 420. For example, the node 420 may broadcast transaction data 450 generated at that node 420 and/or rebroadcast transaction data 450 received from one or more other nodes 420.

The nodes 420 in the distributed network 410 record or register transaction data 450 in a record or ledger (e.g., ledger 240). Each node 420 that generates and/or receives transaction data 450 may independently register the transaction data 450 in a ledger 240 that is local to that node 420. In some examples, the node 420 uses a transaction identifier associated with the transaction data 450 to determine whether to register the transaction data 450. The transaction identifier may include, for example, a public key, a representation of the public key (e.g., an encrypted key, a hash, an encrypted hash), and/or a link to the public key.

If the ledger 240 does not include an instance of the transaction data 450 (e.g., the ledger 240 does not include transaction data associated with a transaction identifier that corresponds to or matches the transaction identifier associated with the transaction data 450), the node 420 registers the transaction data 450 in the ledger 240. On the other hand, if the ledger 240 includes an instance of the transaction data 450, the node 420 implements a consensus protocol 248 to determine whether to accept, reject, or modify the transaction data in the ledger 240 and/or the transaction data 450. If there is consensus among the nodes 420 in the distributed network 410, a transaction 244 associated with the transaction data 450 may be validated.

To facilitate controlling or managing the transaction data 450 in a transparent and verifiable manner, the transaction 244 may be recorded in the ledger 240 using blockchain technology. Data associated with the transaction 244, for example, may be stored on a blockchain. The ledger 240 may be used to demonstrate and/or substantiate that the transaction 244 is legitimate, that the parties to the transaction 244 (e.g., first user 432, second user 442) have the capacity or authority to enter into the transaction 244, and/or that the parties agree to enter into the transaction 244.

A plurality of transactions may be chained together in chronological order to form a block. For example, an input to a transaction may be associated with an output from a previous transaction, and/or an output from a transaction may be associated with an input to a subsequent transaction. In some examples, an output from a transaction may be spent or used once. For example, upon using an output from a transaction as an input to another transaction, the output may be identified or recognized as being spent. Using a spent output as an input to a transaction may render the transaction invalid (e.g., the transaction may be rejected). In some examples, an output may be partitioned for use as an input to a plurality of transactions, and/or a plurality of outputs may be combined for use as an input to a single transaction.

A plurality of blocks may be chained together in chronological order to form a blockchain. A block includes a block header and a hash of a previous block's block header. Additionally, the block header may be hashed and stored in a subsequent block. The block header may include an identifier associated with one or more transactions in the block. In some examples, the transactions in a block are iteratively hashed and paired to generate the identifier (e.g., a merkle root of a merkle tree).

The blocks may be traversed in reverse chronological order to validate one or more transactions in the blockchain. A proof of work, for example, may be used to demonstrate and/or substantiate that one or more operations were performed to validate a transaction and/or generate a block. In some examples, a node 420 in a distributed network 410 may analyze transaction data 450 associated with the transaction 244 to check that a local version of the blockchain is in sync with other versions in the distributed network 410. If the distributed network 410 includes a plurality of versions of the blockchain, a consensus protocol 248 may be implemented to identify a valid version. The valid version may be identified based on a block height or length.

The initiator resource 430, target resource 440, and/or one or more nodes 420 may be used to administer or manage a transaction 244 associated with the transaction request 220. Profile information, for example, may be used to demonstrate and/or substantiate that the first user 432 and/or second user 442 are authorized to access or use the sensor data or profile information and/or to remotely control or monitor the initiator resource 430 or target resource 440. In some examples, the initiator resource 430 and/or target resource 440 are configured to automatically authorize the first user 432 and/or second user 442 to access or use sensor data or profile information and/or to remotely control or monitor the initiator resource 430 or target resource 440. Additionally, or alternatively, one or more nodes 420 are configured to automatically authorize the first user 432 and/or second user 442 to access or use sensor data or profile information and/or to remotely control or monitor the initiator resource 430 or target resource 440. For example, the first user 432 and/or second user 442 may be authorized using the ledger 240.

FIG. 5 is a flowchart illustrating an example method 500 for managing one or more appliances 110. The method 500 may be implemented at the computing device 120. For example, the method 500 may be implemented using the appliance management environment 130 in FIG. 1 and/or the appliance management environment 200 in FIG. 2. Additionally, the method 500 may be implemented in the appliance management environment 300 in FIG. 3 and/or the appliance management environment 400 in FIG. 4.

A transaction request (e.g., transaction request 220) associated with a transfer between a user and a profile manager is received at operation 510. The transaction request 220 may be received from any resource 330 that enables the computing device 120 to function as described herein. For example, the transaction request 220 may be received from an appliance 110 associated with the user or from a first server system 320 associated with the profile manager. The resource 330 is associated with an appliance type (e.g., appliance type 254).

In some examples, the computing device 120 determines at operation 520 whether a transaction ledger (e.g., ledger 240) includes transaction data associated with a reference transaction. The reference transaction is associated with a reference configuration of an appliance associated with the appliance type 254. The computing device 120 may determine whether the ledger 240 includes the transaction data, for example, on condition that the transfer is associated with an initial setup of the resource 330. Additionally, or alternatively, the computing device 120 may determine whether the ledger 240 includes the transaction data on any other condition that enables the IoT ecosystem to function as described herein.

If a determination is made at operation 520 that the ledger 240 includes the transaction data, a configuration instruction is transmitted at operation 530 to the resource 330. The configuration instruction enables the resource 330 to be automatically configured to operate in accordance with the reference configuration. In some examples, the resource 330 analyzes the configuration instruction, and automatically configures the resource 330 in accordance with the reference configuration. Alternatively, the resource 330 may transmit, to the resource 330 or another resource associated with a user of the resource 330 (e.g., user device 160), a prompt instruction to present a prompt presentation for prompting the user to accept the reference configuration, and automatically configures the resource 330 in accordance with the reference configuration upon receiving user input associated with an acceptance of the reference configuration.

A transaction (e.g., transaction 244) associated with the transfer is validated at operation 540. In some examples, the computing device 120 communicates with one or more computing systems (e.g., nodes 420) to validate the transaction 244. For example, the computing device 120 may transmit first transaction data 242 to one or more nodes 420 and/or receive or retrieve second transaction data 246 from one or more nodes 420 to enable the first transaction data 242 to be compared with the second transaction data 246 for validating the transaction 244. Broadcasting the transaction data to a distributed network 410 including the nodes 420 enables a public ledger, including an ordered and timestamped record of the transaction 244, to be generated.

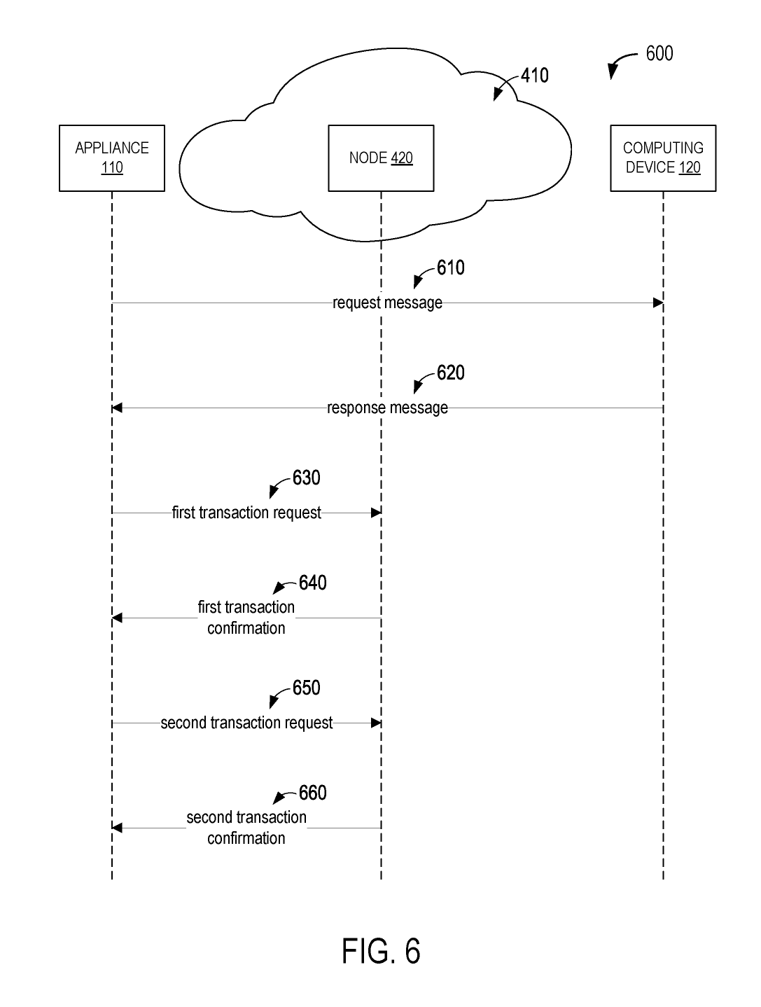

FIG. 6 is a sequence diagram illustrating an example method 600 for managing one or more appliances 110 using a distributed network 410. The method 700 may be implemented using the appliance management environment 130 in FIG. 1 and/or the appliance management environment 200 in FIG. 2 in the appliance management environment 300 in FIG. 3. The method 600 may be used, for example, to automatically set up an appliance 110 upon connecting with the distributed network 410.

An appliance 110 associated with a user (e.g., user 114) may transmit at operation 610 a request message to a computing device 120 associated with a profile manager. In some examples, the request message initiates or starts a session between the appliance 110 and the computing device 120. The request message may be transmitted, for example, to setup the appliance 110. Additionally, or alternatively, the request message may be transmitted to perform any operation that enables the IoT ecosystem to function as described herein.

The computing device 120 processes or analyzes the request message to determine whether to approve or not approve the request message. In some examples, the computing device 120 transmits at operation 620 a response message to the appliance 110. The response message may include, for example, a public key associated with the computing device 120, a representation of the public key (e.g., an encrypted key, a hash, an encrypted hash), and/or link to the public key.

The session includes one or more transactions associated with one or more appliance management actions. The appliance 110 may transmit a first transaction request (e.g., transaction request 220) to one or more nodes 420 in a distributed network 410 at operation 630, and receive a first transaction confirmation from the nodes 420 at operation 640. In some examples, the appliance 110 communicates with the computing device 120 and/or one or more nodes 420 to configure the appliance 110 based on a virtual representation of the appliance 110 (e.g., virtual representation 338). The virtual representation 338 may be associated, for example, with a desired state or configuration (e.g., reference configuration). The virtual representation 338 may be generated or modified at the computing device 120. Additionally, or alternatively, the virtual representation 338 or a modification to the virtual representation 338 may be received or retrieved from one or more computing systems, such as the appliance 110 and/or a user device 160 associated with the user 114. In some examples, the appliance 110 receives or retrieves the virtual representation 338 from the computing device 120 to synchronize a current state or configuration of the appliance 110 with the desired state or configuration. In this manner, the virtual representation 338 may be used to interact with the appliance 110.

If the computing device 120 does not include a virtual representation 338 (e.g., a ledger 240 stored and/or maintained at the computing device 120 does not include transaction data associated with a reference transaction), one or more other transaction ledgers are identified for generating and/or identifying the virtual representation 338. The other transaction ledgers may include, for example, other transaction data that may be used to generate a virtual representation 338. The other transaction data may be associated with one or more other appliances that are associated with an appliance type of the appliance 110 (e.g., appliance type 254). The computing device 120 may process or analyze the other transaction data, for example, to determine the reference configuration associated with the appliance type 254.

In some examples, the appliance 110 transmits a second transaction request (e.g., transaction request 220) to the nodes 420 at operation 650, and receive a second transaction confirmation from the nodes 420 at operation 660. Alternatively, the second transaction request may be transmitted from and/or the second transaction conformation may be transmitted to the user device 160, an appliance other than the appliance 110, and/or a computing system associated with an appliance manager (e.g., an appliance manufacturer). While the example session includes two transactions, the session may include any number of transactions that enable the IoT ecosystem to function as described herein.

In some examples, the appliance 110, user device 160, other appliance, and/or computing system associated with the appliance manager transmits the second transaction request to set or establish a reference transaction. For example, the appliance 110 or user device 160 may communicate with the computing device 120 and/or one or more nodes 420 to recognize or identify a current state or configuration and/or a custom, user-desired state or configuration of the appliance 110 as a reference state or configuration. The reference configuration may be used, in some examples, to configure another appliance associated with the appliance type 254 of the appliance 110 to operate in accordance with the reference configuration. For another example, the other appliance may communicate with the computing device 120 and/or one or more nodes 420 to recognize or identify a current state or configuration and/or a custom, another-user-desired state or configuration of the other appliance 110 as a reference configuration associated with the appliance type 254. For yet another example, the appliance manager may communicate with the computing device 120 and/or one or more nodes 420 to generate and/or identify a reference configuration that enables the appliance 110 to install firmware.

In some examples, the appliance 110 collects, processes, analyzes, and/or acts on data generated at the appliance 110 and/or one or more other computing systems. Event condition action data, for example, may be used to generate one or more triggers for monitoring the appliance 110. The triggers may be responsive to data in the cloud, such as the transaction data. In some examples, the second transaction request is used to generate a trigger configured to present an alert or notification. For example, the trigger may be configured to transmit to one or more computing systems, such as the user device 160 and/or a computing system associated with a security manager, a notification associated with a connection state and/or location of the appliance 110. The trigger may be configured to identify the connection state and/or location of the appliance 110 on condition that the appliance 110 is coupled to one or more nodes 420 in the distributed network 410.

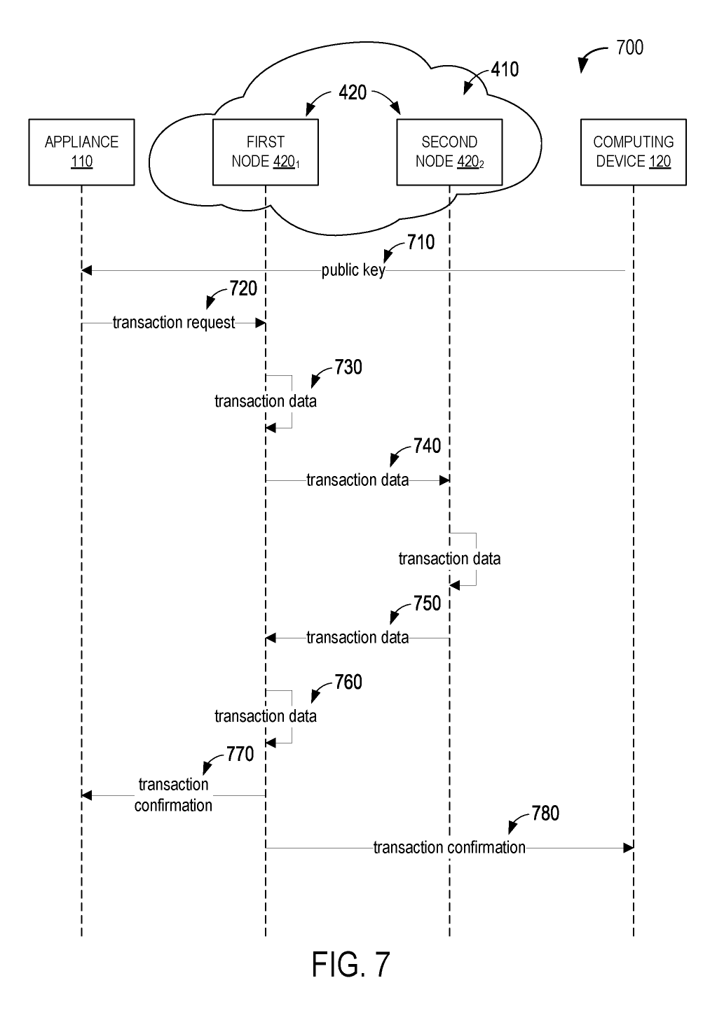

FIG. 7 is a sequence diagram illustrating an example method 700 for managing one or more appliances 110 using the distributed network 410. The method 700 may be implemented using the appliance management environment 130 in FIG. 1 and/or the appliance management environment 200 in FIG. 2 in the appliance management environment 400 in FIG. 4. The method 700 may be used, for example, to record or register transaction data in a public ledger.

An appliance 110 associated with a user (e.g., user 114) may receive at operation 710 an identifier from a computing device 120 associated with a profile manager. The identifier may include, for example, a public key associated with the profile manager, a representation of the public key (e.g., an encrypted key, a hash, an encrypted hash), and/or link to the public key. The appliance 110 uses the identifier to generate a transaction request 220 associated with a transfer between the user 114 and the profile manager.

The appliance 110 may transmit at operation 720 the transaction request 220 to a first node 420₁ of a plurality of nodes 420, and the first node 420₁ may broadcast the transaction request 220 to a distributed network 410 including the nodes 420 to enable the nodes 420 to obtain the transaction request 220. Alternatively, the appliance 110 may broadcast the transaction request 220 to the distributed network 410. Upon receiving the transaction request 220, the first node 420₁ analyzes the transaction request 220 to generate transaction data 450, and registers at operation 730 the transaction data 450 in a ledger (e.g., ledger 240). The first node 420₁ broadcasts the transaction data 450 to the distributed network 410 for validating the transaction data 450. For example, the transaction data 450 may be transmitted at operation 740 to a second node 420₂ of the plurality of nodes 420. If the first node 420₁ receives at operation 750 a remote instance of the transaction data 450 from the second node 420₂, the first node 420₁ analyzes the transaction data 450 to validate at operation 760 the transaction data 450. In some examples, the first node 420₁ generates and transmits at operation 770 a response to the transaction request to the appliance 110. The response may include a transaction confirmation. Additionally, or alternatively, the first node 420₁ may generate and/or transmit at operation 780 a transaction confirmation to the computing device 120.

The examples described herein are configured to support plug-and-play configurations. For example, upon detecting an appliance 110 at an IoT ecosystem, the appliance 110 may be automatically configured to operate in accordance with a reference configuration. The reference configuration may be, for example, a default configuration of an appliance associated with the appliance type 254. Alternatively, the reference configuration may be a user-provided configuration (e.g., via the appliance 110 and/or user device 160), an updated default configuration (e.g., using firmware received from an appliance manager), or another user-provided configuration (e.g., via an appliance and/or user device associated with another user).

If a reference configuration is not available or accessible, a reference configuration may be generating using transaction data and/or profile information associated with one or more other users. For example, the reference configuration may be determined based on profile information associated with the user 114. In some examples, the appliance 110 may be a newer version of another appliance associated with the user 114, and the appliance 110 may be automatically configured to adopt the configuration data associated with the other appliance upon establishing a communication link in the IoT ecosystem (e.g., with the computing device 120, with a node 410). Alternatively, the reference configuration may be determined based on configuration data associated with one or more other appliances associated with one or more other users on condition that the appliances are associated with the appliance type 254.

In some examples, a user 114 may report an appliance 110 as lost or stolen. If the appliance 110 is reported as lost or stolen, an alert associated with the appliance 110 may be generated and transmitted upon detecting the appliance 110. For example, a connection status and/or location of the appliance 110 may be reported to the user 110 (e.g., via a user device 160) and/or to a security manager upon identifying that the appliance 110 is coupled to the IoT ecosystem and/or that a user other than the user 114 is accessing or using the appliance 110.

In other examples, the appliance 110 may be a kiosk used for controlled receipt of packages, such as those packages delivered autonomously via unmanned aerial vehicle (UAV) or automated guided vehicle (AGV). In this illustrative example, a user may obtain a kiosk and add the newly obtained kiosk to the distributed ledger structure utilizing their smart device to provision and/or authorize the kiosk. In one example, the user device may be a wearable device that maintains the private key used to authorize the transaction. The kiosk may sync with the user device and be automatically provisioned as a home delivery station and added as a device in the distributed ledger management system. A user may configure customized levels of access and/or control for the kiosk, such as the ability to accept or decline a package or the ability to create and order an item, and so on, via the management environment (e.g. appliance management environment 130). The device may also be preloaded or preconfigured with device logic for customized levels of control and access, based on user preferences.

In addition, a user may view and modify levels of control and access of devices provisioned and/or deprovisioned in the system. For example, if the user obtains a new device, replacement device, or updated device (e.g. a new kiosk to replace an existing kiosk), an existing device may be removed, or deprovisioned, from the management system on the distributed ledger. This enables a user to dynamically control and modify the levels of access and control for each device on the system. As another example, a user may modify a level of access for dedicated or pre-defined time intervals, such as disabling a kiosk's ability to accept a package when the user is away on vacation.

The system and methods provided herein enable a user to access and view historical data pertaining to device actions, decisions, and the like, which are saved in the distributed ledger. All actions, negotiations, transactions, and interactions made by the device generate subsequent blocks stored in the chain of the distributed ledger. This enables a user to view previous interactions and transactions made by a device at their discretion.

Alternatively, or in addition to the other examples described herein, examples include any combination of the following:
determining whether a smart appliance is at least initially setup;
generating a transaction request to include a request for configuration;
identifying a transaction request associated with a transfer between a user and a profile manager;
identifying a network including one or more nodes;
determining whether the transfer is associated with an initial setup of a smart appliance;
determining whether a transaction ledger includes transaction data associated with a reference transaction;
automatically associating the smart appliance with a reference configuration such that the smart appliance is configured to operate in accordance with one or more appliance settings associated with the reference configuration;
identifying a prompt instruction to prompt the user to accept the reference configuration;
presenting a prompt presentation associated with the prompt instruction;
identifying user input associated with an acceptance of the reference configuration;
identifying a configuration instruction to automatically configure the smart appliance to operate in accordance with the reference configuration;
validating a transaction associated with the transfer;
identifying a confirmation of the transaction;
identifying a notification associated with a validation of the transaction associated with the transfer;
identifying user input associated with a custom configuration of the smart appliance;
identifying a transaction request associated with the custom configuration of the smart appliance;
identifying a transaction as the reference transaction;
identifying another transaction ledger that includes other transaction data associated with the appliance type of the smart appliance;
analyzing the other transaction data to determine the reference configuration associated with the appliance type of the smart appliance;
identifying a transaction request associated with firmware of the appliance type of the smart appliance;
identifying an installation instruction to install the firmware at the smart appliance;
determining whether the smart appliance is coupled to one or more nodes in a network;
identifying a transaction request associated with an alert;
identifying a connection state and a location of the smart appliance;
identifying a notification associated with the connection state of the smart appliance;
identifying a notification associated with the location of the smart appliance;
a client component configured to receive a transaction request associated with a transfer between a user and a profile manager, and transmit a response to the transaction request;
a consensus component configured to generate a local instance of the transaction request, transmit the local instance of the transaction request to one or more nodes in a network, receive one or more remote instances of the transaction request from the one or more nodes in the network, and implement a consensus protocol to validate a transaction associated with the transfer;
a manager component configured to identify a reference transaction associated with a reference configuration of a smart appliance associated with an appliance type;
a manager component configured to obtain a custom configuration associated with the appliance type, and determine whether to identify the custom configuration as the reference configuration associated with the appliance type;
a manager component configured to identify one or more transaction ledgers that include transaction data associated with one or more other transactions, and analyze the transaction data to determine the reference configuration associated with the appliance type; and
a trigger component configured to monitor the smart appliance and/or a user or the smart appliance, and automatically configure the smart appliance to operate in accordance with the reference configuration.

In some examples, the operations illustrated in FIGS. 2, 5, 6, and 7 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure. Moreover, the appliance management environment described herein may be used in a broad range of environments including, without limitation, a home environment, a media environment, an environmental monitoring environment, a manufacturing environment, an energy management environment, a healthcare environment, a transportation environment, a retail environment, an agricultural environment, and the like. While at least some examples of the disclosure are directed to an appliance management environment, aspects of the disclosure may be provided in a variety of environments in which an environment is monitored and managed.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

### Example Operating Environment

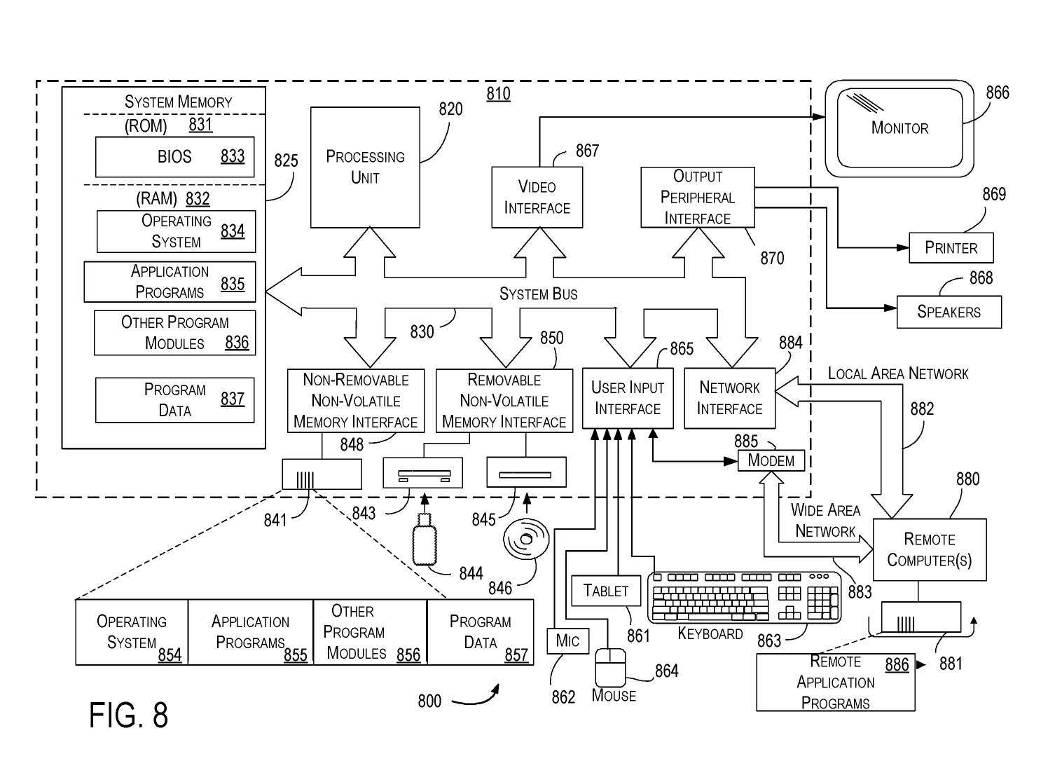

FIG. 8 is a block diagram illustrating an example operating environment 800 for a computing device (e.g., computing device 120). The computing system environment 800 is only one example of a suitable computing environment and is not intended to suggest any limitation as to the scope of use or functionality of the disclosure. Neither should the computing environment 800 be interpreted as having any dependency or requirement relating to any one or combination of components illustrated in the example operating environment 800.

The disclosure is operational with numerous other general purpose or special purpose computing system environments or configurations. Examples of well-known computing systems, environments, and/or configurations that may be suitable for use with the disclosure include, but are not limited to: personal computers, desktop computers, laptop computers, tablet devices, netbooks, handheld devices, mobile telephones, wearables, gaming devices, portable media players, server computers, kiosks, set top boxes, tabletop devices, multiprocessor systems, microprocessor-based systems, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, and so forth, which perform particular tasks or implement particular abstract data types. The disclosure may also be practiced in distributed computing environments where tasks are performed by remote processing devices that are linked through a communications network. In a distributed computing environment, program modules may be located in local and/or remote computer storage media including memory storage devices and/or computer storage devices. As used herein, computer storage devices refer to hardware devices.

With reference to FIG. 8, an example system for implementing various aspects of the disclosure may include a general purpose computing device in the form of a computer 810. Components of the computer 810 may include, but are not limited to, a processing unit 820, a system memory 825, and a system bus 830 that couples various system components including the system memory to the processing unit 820. The system bus 830 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 810 typically includes a variety of computer-readable media. Computer-readable media may be any available media that may be accessed by the computer 810 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or the like. Read only memory (ROM) 831 and random-access memory (RAM) 832 are examples of computer storage media. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information, and which may be accessed by the computer 810. Computer storage media does not, however, include propagated signals. Rather, computer storage media excludes propagated signals. Any such computer storage media may be part of computer 810.

Communication media typically embodies computer-readable instructions, data structures, program modules or the like in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The system memory 825 includes computer storage media in the form of volatile and/or nonvolatile memory such as ROM 831 and RAM 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs, such as application programs 835 (e.g., appliance management environment), other program modules 836 and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a universal serial bus (USB) port 843 that provides for reads from or writes to a removable, nonvolatile memory 844, and an optical disk drive 845 that reads from or writes to a removable, nonvolatile optical disk 846 such as a CD ROM or other optical media. Other removable/non-removable, volatile/nonvolatile computer storage media that may be used in the example operating environment include, but are not limited to, magnetic tape cassettes, flash memory cards, digital versatile disks, digital video tape, solid state RAM, solid state ROM, and the like. The hard disk drive 841 is typically connected to the system bus 830 through a non-removable memory interface such as interface 848, and USB port 843 and optical disk drive 845 are typically connected to the system bus 830 by a removable memory interface, such as interface 850.

The drives and their associated computer storage media, described above and illustrated in FIG. 8, provide storage of computer-readable instructions, data structures, program modules and other data for the computer 810. In FIG. 8, for example, hard disk drive 841 is illustrated as storing operating system 854, application programs 855 (e.g., an appliance management environment), other program modules 856 and program data 857. Note that these components may either be the same as or different from operating system 834, application programs 835, other program modules 836, and program data 837. Operating system 854, application programs 855, other program modules 856, and program data 857 are given different numbers herein to illustrate that, at a minimum, they are different copies.

A user may enter commands and information into the computer 810 through input devices such as a tablet, or electronic digitizer, 861, a microphone 862, a keyboard 863 and pointing device 864, commonly referred to as mouse, trackball or touch pad. Other input devices not shown in FIG. 8 may include a joystick, game pad, digital camera, scanner, or the like. These and other input devices are often connected to the processing unit 820 through a user input interface 865 that is coupled to the system bus, but may be connected by other interface and bus structures, such as a parallel port, game port or a universal serial bus (USB). A monitor 866 or other type of display device is also connected to the system bus 830 via an interface, such as a video interface 867. The monitor 866 may also be integrated with a touchscreen panel or the like. Note that the monitor and/or touchscreen panel may be physically coupled to a housing in which the computing device 810 is incorporated, such as in a tablet device. In addition, computers such as the computing device 810 may also include other peripheral output devices such as speakers 868 and printer 869, which may be connected through an output peripheral interface 870 or the like.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include one or more local area networks (LAN) 882 and one or more wide area networks (WAN) 883, but may also include other networks. Such networking environments are commonplace in offices, enterprise-wide computer networks, intranets and the Internet.

When used in a LAN networking environment, the computer 810 is connected to the LAN 882 through a network interface controller or adapter 884. When used in a WAN networking environment, the computer 810 typically includes a modem 885 or other means for establishing communications over the WAN 883, such as the Internet. The modem 885, which may be internal or external, may be connected to the system bus 830 via the user input interface 860 or other appropriate mechanism. A wireless networking component such as comprising an interface and antenna may be coupled through a suitable device such as an access point or peer computer to a WAN or LAN. In a networked environment, program modules depicted relative to the computer 810, or portions thereof, may be stored in the remote memory storage device. By way of example, and not limitation, FIG. 8 illustrates remote application programs 885 as residing on memory device 881. It may be appreciated that the network connections shown are exemplary and other means of establishing a communication link between the computers may be used.

The examples illustrated and described herein as well as examples not specifically described herein but within the scope of aspects of the disclosure constitute an example appliance management environment. For example, the elements illustrated in FIGS. 1-4 and 6-8, such as when encoded to perform the operations illustrated in FIGS. 2 and 5-7, constitute an example means for receiving a transaction request associated with a transfer between a user and a profile manager (e.g., client module 132, client component 202); an example means for determining whether a transaction ledger includes transaction data associated with a reference transaction (e.g., registration module 136, manager module 140, trigger module 142, registration component 206, manager component 210, trigger component 212); an example means for transmitting a configuration instruction to automatically configure the smart appliance to operate in accordance with the reference configuration (e.g., client module 132, client component 202); and/or an example means for communicating with one or more nodes in a network to validate a transaction associated with the transfer (e.g., consensus module 138, consensus component 208).

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A computer-implemented method for managing one or more smart appliances, the computer-implemented method comprising:
receiving, from a first smart appliance of the one or more smart appliances, a first transaction request, the first transaction request associated with a first transfer between a user and a profile manager, the first smart appliance associated with an appliance type;
determining whether a transaction ledger includes transaction data associated with a reference transaction, the reference transaction associated with a reference configuration of an appliance associated with the appliance type; and
on condition that the transaction ledger includes the transaction data:
transmitting, to the first smart appliance, a first configuration instruction to automatically configure the first smart appliance to operate in accordance with the reference configuration; and
communicating with one or more nodes in a network to validate a first transaction associated with the first transfer.

2. The computer-implemented method of claim 1, further comprising transmitting, to the first smart appliance and to a computing system associated with the profile manager, a confirmation of the first transaction.

3. The computer-implemented method of claim 1, further comprising transmitting, to the first smart appliance, a prompt instruction to prompt the user to accept the reference configuration, wherein the first configuration instruction is transmitted upon receiving user input associated with an acceptance of the reference configuration.

4. The computer-implemented method of claim 1, further comprising determining whether the first transfer is associated with an initial setup of the first smart appliance, wherein it is determined whether the transaction ledger includes the transaction data on condition that the first transfer is associated with the initial setup of the first smart appliance.

5. The computer-implemented method of claim 1 further comprising:
receiving, from the first smart appliance, a second transaction request, the second transaction request associated with a second transfer between the user and the profile manager, the second transfer associated with an acceptance of the reference configuration;
communicating with the one or more nodes in the network to validate a second transaction associated with the second transfer; and
identifying the second transaction as the reference transaction.

6. The computer-implemented method of claim 1 further comprising:
receiving, from the first smart appliance, a second transaction request, the second transaction request associated with a second transfer between the user and the profile manager, the second transfer associated with a custom configuration of the first smart appliance;
communicating with the one or more nodes in the network to validate a second transaction associated with the second transfer; and
identifying the second transaction as the reference transaction, such that the custom configuration is identified as the reference configuration associated with the appliance type.

7. The computer-implemented method of claim 1 further comprising:
receiving, from a second smart appliance of the one or more smart appliances, a second transaction request, the second transaction request associated with a second transfer between the user and the profile manager;
identifying that the second smart appliance is associated with the appliance type,
transmitting, to the second smart appliance, a second configuration instruction to automatically configure the second smart appliance to operate in accordance with the reference configuration; and
communicating with the one or more nodes in the network to validate a second transaction associated with the second transfer.

8. The computer-implemented method of claim 1 further comprising:
receiving, from a second smart appliance of the one or more smart appliances, a second transaction request, the second transaction request associated with a second transfer between the user and the profile manager, the second transfer associated with a custom configuration of the second smart appliance, the second smart appliance associated with the appliance type;
determining whether the first smart appliance is coupled to the one or more nodes in the network; and
on condition that the first smart appliance is coupled to the one or more nodes in the network, transmitting, to the first smart appliance, a second configuration instruction to automatically configure the first smart appliance to operate in accordance with the custom configuration.

9. The computer-implemented method of claim 1 further comprising:
on condition that the transaction ledger does not include the transaction data:
identifying one or more other transaction ledgers that include other transaction data associated with one or more other transactions, the one or more other transactions associated with the appliance type; and
analyzing the other transaction data to determine the reference configuration associated with the appliance type.

10. The computer-implemented method of claim 1 further comprising:
receiving, from a computing system associated with an appliance manager, a second transaction request, the second transaction request associated with a transfer between the appliance manager and the profile manager, the transfer associated with firmware of the appliance type;
communicating with the one or more nodes in the network to validate a second transaction associated with the transfer;
determining whether the first smart appliance is coupled to the one or more nodes in the network; and
on condition that the first smart appliance is coupled to the one or more nodes in the network, transmitting, to the first smart appliance, an installation instruction to install the firmware at the first smart appliance.

11. The computer-implemented method of claim 1 further comprising:
receiving a second transaction request, the second transaction request associated with a second transfer between the user and the profile manager, the second transfer associated with an alert, the alert associated with the first smart appliance;
communicating with the one or more nodes in the network to validate a second transaction associated with the second transfer;
determining whether the first smart appliance is coupled to the one or more nodes in the network; and
on condition that the first smart appliance is coupled to the one or more nodes in the network:
identifying a connection state and a location of the first smart appliance;
transmitting, to a user device associated with the user, a first notification, the first notification associated with the connection state of the first smart appliance; and
transmitting, to a computing system associated with a security manager, a second notification, the second notification associated with the location of the first smart appliance.

12. A computing system for managing a smart appliance, the computing system comprising:
a memory device storing data associated with the smart appliance and computer-executable instructions, the smart appliance associated with an appliance type; and
a processor configured to execute the computer-executable instructions to:
identify a network including one or more nodes;
transmit, to the one or more nodes, a first transaction request, the first transaction request associated with a first transfer between a user and a profile manager;
receive, from the one or more nodes, a configuration instruction to configure the first smart appliance to operate in accordance with a reference configuration associated with the appliance type; and
receive, from the one or more nodes, a notification associated with a validation of a first transaction associated with the first transfer.

13. The computing system of claim 12, wherein the processor is further configured to execute the computer-executable instructions to automatically associate the smart appliance with the reference configuration such that the smart appliance is configured to operate in accordance with one or more appliance settings associated with the reference configuration.

14. The computing system of claim 12, wherein the processor is further configured to execute the computer-executable instructions to:
determine whether the smart appliance is at least initially setup; and
on condition that the smart appliance is not at least initially setup, generate the first transaction request to include a request for configuration.

15. The computing system of claim 12, wherein the processor is further configured to execute the computer-executable instructions to:
receive, from the one or more nodes, a prompt instruction to prompt the user to accept the reference configuration;
present, at a user interface, a prompt presentation associated with the prompt instruction;
receive, from the user interface, user input associated with an acceptance of the reference configuration; and
transmit, to the one or more nodes, a second transaction request, the second transaction request associated with a second transfer between the user and the profile manager, the second transfer associated with the acceptance of the reference configuration.

16. The computing system of claim 12, wherein the processor is further configured to execute the computer-executable instructions to
receive, from a user interface, user input associated with a custom configuration of the smart appliance; and
transmit, to the one or more nodes, a second transaction request, the second transaction request associated with a second transfer between the user and the profile manager, the second transfer associated with the custom configuration of the smart appliance.

17. The computing system of claim 12, wherein the processor is further configured to execute the computer-executable instructions to receive, from the one or more nodes, an installation instruction to install firmware at the smart appliance.

18. One or more computer storage media embodied with computer-executable instructions, the one or more computer storage media comprising:
a client component that, upon execution by at least one processor, receives a transaction request associated with a transfer between a user and a profile manager, and transmits a response to the transaction request;
a consensus component that, upon execution by the at least one processor, generates a local instance of the transaction request, transmits the local instance of the transaction request to one or more nodes in a network, receives one or more remote instances of the transaction request from the one or more nodes in the network, and implements a consensus protocol to validate a transaction associated with the transfer;
a manager component that, upon execution by the at least one processor, identifies a reference transaction associated with a reference configuration of an appliance associated with an appliance type; and
a trigger component that, upon execution by the at least one processor, monitors one or more of the user or the appliance, and, if a smart appliance associated with the appliance type is identified, automatically configures the smart appliance to operate in accordance with the reference configuration.

19. The one or more computer storage media of claim 18, wherein the manager component is configured to:
obtain a custom configuration associated with the appliance type; and
determine whether to identify the custom configuration as the reference configuration associated with the appliance type.

20. The one or more computer storage media of claim 18, wherein the manager component is configured to:
identify one or more transaction ledgers that include transaction data associated with one or more other transactions, the one or more other transactions associated with the appliance type; and
analyze the transaction data to determine the reference configuration associated with the appliance type.
